(19) United States
(12) Patent Application Publication
(10) Pub. No.: US 2012/0054924 A1
(43) Pub. Date: Mar. 1, 2012

(54) SPM Probe and Inspection Device for Light Emission Unit

(75) Inventors: Kaifeng ZHANG, Yokohama (JP); Takenori HIROSE, Tokyo (JP); Tsuneo NAKAGOMI, Nakai (JP); Masahiro WATANABE, Yokohama (JP)

(73) Assignee: Hitachi High-Technologies Corporation, Tokyo (JP)

(21) Appl. No.: 13/192,910

(22) Filed: Jul. 28, 2011

(30) Foreign Application Priority Data
Aug. 25, 2010 (JP) 2010-188651

(51) Int. Cl. G01Q 20/02; G01Q 70/08

(52) U.S. Cl. 850/6; 850/56

(57) ABSTRACT

An SPM probe includes: an SPM cantilever; a thermal resistance formed at a probe portion of the SPM cantilever; an insulating film formed on the thermal resistance; and one wire for converting the micro-scale energy source into heat or propagating light, formed on the insulating film.

### CROSS-REFERENCE TO RELATED APPLICATION

The present application claims priority from Japanese Patent Application No. 2010-188651 filed on Aug. 25, 2010, the content of which is hereby incorporated by reference into this application.

### TECHNICAL FIELD OF THE INVENTION

The present invention relates to an SPM probe for measuring energy of near-field light (micro-scale energy source). More particularly, the present invention relates to achieve a high resolution of the SPM probe.

### BACKGROUND OF THE INVENTION

In recent years, employment of a near-field light head has been planned as a next-generation hard disk head. A width of the near-field light (micro-scale energy source) generated from the near-field light head is 20 nm or smaller, and therefore, a method of inspecting a space distribution of the near-field light in actual operation is one of unsolved problems.

Conventionally, it has been considered that an SPM (Scanning Probe Microscope) technique which is a nondestructive and high space resolution inspection technique with using a cantilever provided with a thermal resistance or a thermocouple is used based on an atomic force microscope (AFM) inspection technique.

As a technique of providing the thermocouple technique to the cantilever, there are techniques described in, for example, K. Luo, Z. Shi, J. Lai, and A. Majumdar, Appl. Phys. Lett. 68, pp. 325 to 327 (1996) (Non-Patent Document 1) and G. Mills, H. Zhou, A. Midha, L. Donaldson, and J. M. R. Weaver, Appl. Phys. Lett. 72, pp. 2900 to 2902 (1998) (Non-Patent Document 2).

In the technique described in Non-Patent Document 1, a three-layered thin film made of gold, silicon oxide, and nickel is vapor-deposited on the cantilever, and a thermocouple junction whose size is 100 to 300 nm is formed at a tip portion of a pyramid-shaped probe whose size is about 5 μm. The document reports that, while this technique has problems in manufacturing difficulty and endurance, a space resolution of about 10 nm for temperature measurement a temperature can be achieved by this probe.

Also, the technique described in Non-Patent Document 2 provides a thermocouple manufactured by collective manufacturing (batch type) with using a microfabrication technique. A thin film made of gold and palladium is vapor-deposited on a cantilever, and a thermocouple junction whose size is about 250 nm is formed at a tip portion. The document reports that a curvature radius of the tip portion is about 50 nm, and a space resolution for thermal measurement is 40 nm or lower.

Meanwhile, Japanese Patent Application Laid-Open Publication No. 2007-86079 (Patent Document 1) describes a technique of providing a CNT (carbon nanotube) to the thermocouple cantilever of the Non-Patent Document 1, and Japanese Patent No. 3925610 (Patent Document 2) describes a technique of using a CNT as apart of a thermal resistance to be an electrical and heat conductor.

### SUMMARY OF THE INVENTION

However, the above-described methods are very difficult to achieve the microfabrication or the control for the size in the formation of the thermal resistance or the thermocouple, and therefore, the detection of the space distribution of the energy source such as near-field light whose width is several to several tens of nanometer with high space resolution is another one of problems.

Also, in order to detect the near-field light, there is a method of scattering the light and directly detecting the scattered light. However, there are problems such that the detection with high resolution similar to the above description cannot be achieved, influence on a sample should be suppressed as small as possible as a measurement device, and a manufacturing method should be simplified.

Further, in the Patent Document 1, the thermocouple described in the Non-Patent Document 1 is directly used to specify only the CNT, and a connection method or others is not described, and therefore, there are problems such that other material than the CNT is not used and how the CNT is mounted.

Still further, in the Patent Document 2, it is considered that there is a possibility of electrically affecting a measured substance because the CNT is a part of an electrical circuit, and that it is difficult to select an adhesive for fixing the CNT, to provide an adhesion point whose size is several tens of nanometers (difficult to form the adhesion point) for that, and others.

Accordingly, the present invention provides an SPM probe which can be manufactured by a simple work and which can observe the space distribution of the micro-scale energy source such as the near-field light and microwave without electrically affecting the measured substance and with a wide measurement range and a high space resolution.

The above and other preferred aims and novel characteristics of the present invention will be apparent from the description of the present specification and the accompanying drawings.

The typical ones of the inventions disclosed in the present application will be briefly described as follows.

That is, the typical ones are summarized to include: an SPM cantilever; a thermal resistance formed at a probe portion of the SPM cantilever; an insulating film formed on the thermal resistance; and one wire for converting the micro-scale energy source formed on the insulting film into heat.

The effects obtained by typical aspects of the present invention in the present application will be briefly described below.

That is, as the effects obtained by typical aspects, the space distribution of the micro-scale energy source such as the near-field light and microwave can be observed with the wide measurement range and the high space resolution.

These and other objects, features and advantages of the invention will be apparent from the following more particular description of preferred embodiments of the invention, as illustrated in the accompanying drawings.

### BRIEF DESCRIPTIONS OF THE DRAWINGS

FIG. 1 is a configuration diagram showing a configuration of an SPM probe according to a first embodiment of the present invention;

FIG. 2A is a diagram showing a method of manufacturing the SPM probe according to the first embodiment of the present invention;

FIG. 2B is a diagram showing the method of manufacturing the SPM probe according to the first embodiment of the present invention;

FIG. 2C is a diagram showing the method of manufacturing the SPM probe according to the first embodiment of the present invention;

FIG. 3 is a configuration diagram showing a configuration of an SPM probe according to a second embodiment of the present invention;

FIG. 4A is a diagram showing a method of manufacturing the SPM probe according to the second embodiment of the present invention;

FIG. 4B is a diagram showing the method of manufacturing the SPM probe according to the second embodiment of the present invention;

FIG. 4C is a diagram showing the method of manufacturing the SPM probe according to the second embodiment of the present invention;

FIG. 4D is a diagram showing the method of manufacturing the SPM probe according to the second embodiment of the present invention;

FIG. 4E is a diagram showing the method of manufacturing the SPM probe according to the second embodiment of the present invention;

FIG. 4F is a diagram showing the method of manufacturing the SPM probe according to the second embodiment of the present invention;

FIG. 5 is a configuration diagram showing a configuration of an SPM probe according to a third embodiment of the present invention;

FIG. 6A is a diagram showing a method of manufacturing the SPM probe according to the third embodiment of the present invention;

FIG. 6B is a diagram showing the method of manufacturing the SPM probe according to the third embodiment of the present invention;

FIG. 7 is a configuration diagram showing a configuration of an SPM probe according to a fourth embodiment of the present invention;

FIG. 8 is a configuration diagram showing a configuration of an SPM probe according to a fifth embodiment of the present invention;

FIG. 9A is a diagram showing a method of manufacturing the SPM probe according to the fifth embodiment of the present invention;

FIG. 9B is a diagram showing the method of manufacturing the SPM probe according to the fifth embodiment of the present invention;

FIG. 9C is a diagram showing the method of manufacturing the SPM probe according to the fifth embodiment of the present invention;

FIG. 9D is a diagram showing the method of manufacturing the SPM probe according to the fifth embodiment of the present invention;

FIG. 10 is a configuration diagram showing a configuration of an SPM probe according to a sixth embodiment of the present invention;

FIG. 11A is a diagram showing a method of manufacturing the SPM probe according to the sixth embodiment of the present invention;

FIG. 11B is a diagram showing the method of manufacturing the SPM probe according to the sixth embodiment of the present invention;

FIG. 11C is a diagram showing the method of manufacturing the SPM probe according to the sixth embodiment of the present invention;

FIG. 12 is a diagram showing a basic configuration of an inspection device for a near-field light emission unit with using an SPM probe according to a seventh embodiment of the present invention;

FIG. 13 is a diagram showing a device configuration of the inspection device for the near-field light emission unit with using the SPM probe according to the seventh embodiment of the present invention;

FIG. 14A is a diagram showing a procedure in measurement by the inspection device for the near-field light emission unit with using the SPM probe according to the seventh embodiment of the present invention;

FIG. 14B is a diagram showing the procedure in measurement by the inspection device for the near-field light emission unit with using the SPM probe according to the seventh embodiment of the present invention;

FIG. 14C is a diagram showing the procedure in measurement by the inspection device for the near-field light emission unit with using the SPM probe according to the seventh embodiment of the present invention;

FIG. 14D is a diagram showing the procedure in measurement by the inspection device for the near-field light emission unit with using the SPM probe according to the seventh embodiment of the present invention; and

FIG. 14E is a diagram showing the procedure in measurement by the inspection device for the near-field light emission unit with using the SPM probe according to the seventh embodiment of the present invention.

### DESCRIPTIONS OF THE PREFERRED EMBODIMENTS

First, a summary of the present invention is described.

In the present invention, in order to improve a conventional SPM probe so that the micro-scale energy source such as the near-field light can be detected, the micro-scale energy source is converted into heat, and the distribution of the heat is detected, so that the space distribution of the micro-scale energy source can be calculated.

Therefore, at a tip portion of the SPM probe, a sensor and a wire which can convert a mode of the micro-scale energy source (mainly, into heat) and can conduct the heat are added.

And, a tip portion of the added wire is contacted to the micro-scale energy source to convert an energy mode such as light and microwave into another mode (mainly, heat), and the converted energy is propagated toward a neck of the wire and is detected by the sensor positioned at the neck.

Also, by providing a combined body of the sensor and the wire to the SPM probe, the distribution of the energy source can be directly or indirectly detected similarly to the above description.

Further, as long as the sensor is energized or generates electrical signals such as the thermal resistance or the thermocouple, a function of the wire is only the energy conversion and propagation by previously providing an insulating film with good thermal conductivity, and then, adding the wire, so that the sensor is designed so as not to electrically affect the measured substance.

Still further, when the wire is a CNF (carbon nanofiber), a metal wire, or others, the additional method is a self-growth method by mainly irradiating high-energy ion beam, and therefore, the work is simple, and individual variability is not caused much.

Hereinafter, embodiments of the present invention will be described in detail with reference to the accompanying drawings. Note that components having the same function are denoted by the same reference symbols throughout the drawings for describing the embodiments, and the repetitive description thereof will be omitted.

### FIRST EMBODIMENT

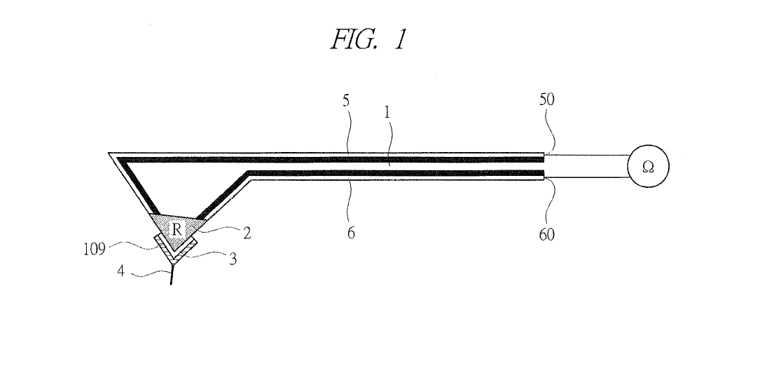

With reference to FIG. 1, a configuration of an SPM probe according to a first embodiment of the present invention is described. FIG. 1 is a configuration diagram showing the configuration of the SPM probe according to the first embodiment of the present invention.

In FIG. 1, the SPM probe includes: an SPM cantilever 1; a thermal resistance 2 provided at a probe portion of the SPM cantilever; an insulating film 3 with good thermal conductivity provided on the thermal resistance 2; a wire 4 having a function of converting light provided on the insulating film 3 into heat; metal films 5 and 6 for connecting the thermal resistance 2; and electrodes 50 and 60.

A function of each unit in the measurement is as follows.

The SPM cantilever 1 is the same as that of a general AFM device. However, the thermal resistance 2 and the metal films 5 and 6 provided at the tip portion are energized as apart of a measurement circuit, so that a resistance of the thermal resistance 2 can be measured via the electrode 50 and 60.

The wire 4 is contacted to the measured substance (here, the near-field light) as the probe of the SPM cantilever 1, and its portion contacted to the measured substance generates heat and propagates the heat toward the neck of the probe because the wire 4 has the function of converting the light into the heat and the thermal conductive function.

The insulating film 3 is arranged between the thermal resistance 2 and the wire 4 and has the good thermal conductivity, and therefore, the thermal resistance 2 detects temperature change of the neck of the wire 4 by measuring its resistance value via the electrodes 50 and 60, so that the near-field light can be measured.

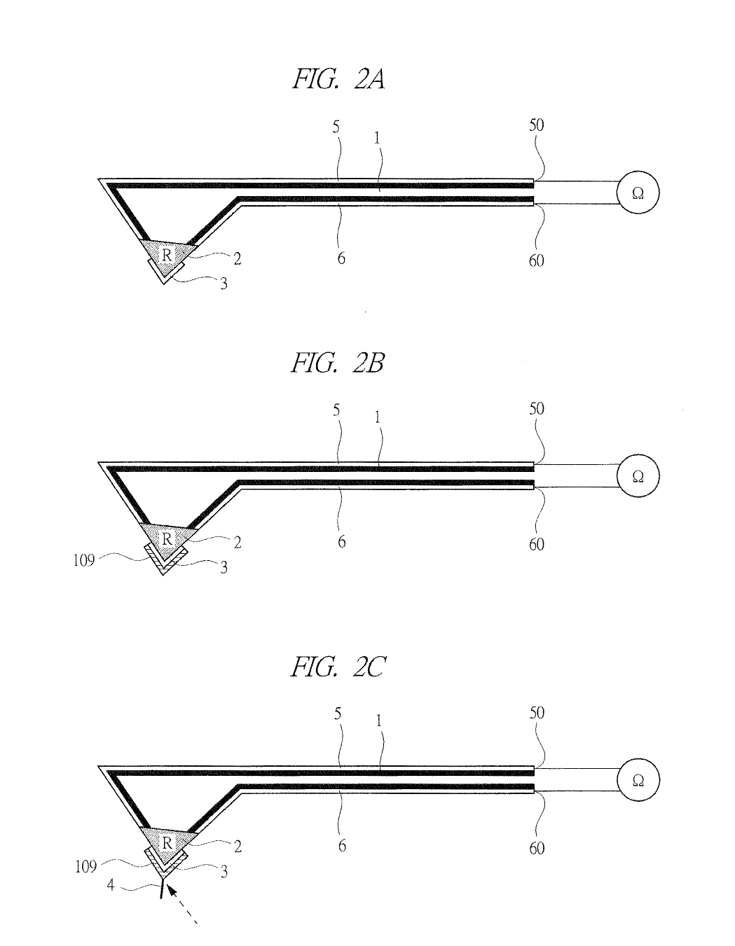

Next, with reference to FIGS. 2A to 2C, a method of manufacturing the SPM probe according to the first embodiment of the present invention is described. FIGS. 2A to 2C are diagrams each showing the method of manufacturing the SPM probe according to the first embodiment of the present invention.

First, on the thermal resistance 2 of the SPM cantilever 1 to which the thermal resistance 2 is provided, the insulating film 3 with good thermal conductivity is formed [FIG. 2A]. On the insulating film 3, a carbon film 109 is further deposited [FIG. 2B].

By irradiating the high-energy beam (in vacuum) to the carbon film 109 in this state, single CNF (wire 4 made of carbon nanofiber) is grown on only the tip portion [FIG. 2C].

Since the CNF is formed by a bonding of a diamond structure of carbon and a graphite structure thereof, the contact of the CNF to the near-field light generates the heat and causes a superior thermal conductivity, and therefore, the measurement with the high space resolution can be achieved.

### SECOND EMBODIMENT

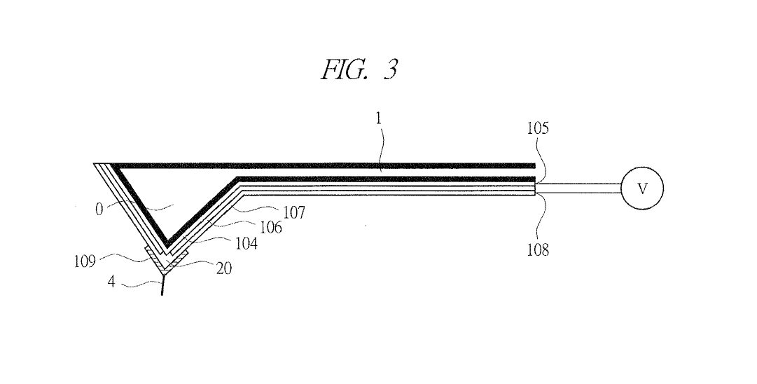

With reference to FIG. 3, a configuration of an SPM probe according to a second embodiment of the present invention is described. FIG. 3 is a configuration diagram showing the configuration of the SPM probe according to the second embodiment of the present invention.

In FIG. 3, the SPM probe includes: an SPM cantilever 1; a thermocouple 20 provided at a probe portion of the SPM cantilever 1; a wire 4 having a function of converting light provided on the thermocouple 20 into heat; metal films 104 and 107 for connecting the thermocouple 20; and electrodes 105 and 108.

A function of each unit in the measurement is as follows.

The SPM cantilever 1 is the same as that of a general AFM device. However, the thermocouple 20 and the metal films 104 and 107 provided at the tip portion are energized as apart of a measurement circuit, so that a voltage of the thermocouple 20 can be measured via the electrodes 105 and 108.

The wire 4 is contacted to the measured substance (here, the near-field light) as the probe of the SPM cantilever 1, and its portion contacted to the measured substance generates heat and propagates the heat toward the neck of the probe because the wire 4 has the function of converting the light into the heat and the thermal conductive function. Since the thermocouple 20 exists at the neck of the wire 4, it detects temperature change of the neck of the wire 4.

The change of the voltage value of the thermocouple 20 is measured via the electrodes 105 and 108, so that the near-field light can be measured.

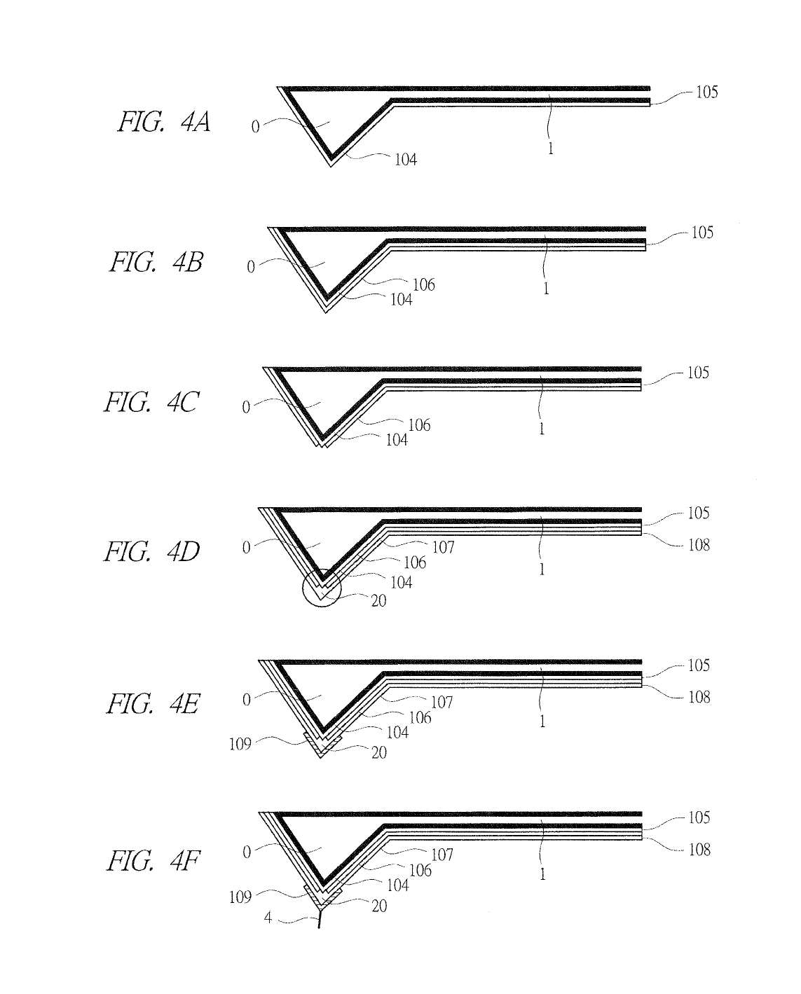

Next, with reference to FIGS. 4A to 4F, a method of manufacturing the SPM probe according to the second embodiment of the present invention is described. FIGS. 4A to 4F are diagrams each showing the method of manufacturing the SPM probe according to the second embodiment of the present invention.

First, the metal film 104 is coated on a free-end protruding portion 0 side of the SPM cantilever 1, and the electrode 105 is provided to a fix end thereof [FIG. 4A]. On the metal film 104, an insulating film 106 is coated [FIG. 4B].

And then, the insulating film existing in a slight area at a top point of the free-end protruding portion 0 (area of about 50 to 100 nm in a periphery of the top point) is removed [FIG. 4C]. Similarly, the metal film 107 (which is made of a different substance from the substance used for the above-described metal film 104) is coated, and another one electrode 108 is provided to the fix end [FIG. 4D].

in a tip portion of the free-end protruding portion 0 where the insulating film does not exist, the thermocouple 20 is formed by a junction of the metal films 104 and 107. For a substance for forming the thermocouple, there is a method of, for example, combining gold and platinum (however, other type of metal can be also used for the thermocouple).

And then, on the thermocouple 20, the carbon film 109 is deposited [FIG. 4E]. By irradiating the high-energy beam (in vacuum) to the carbon film 109, single CNF (wire 4 made of carbon nanofiber) is grown on only the tip portion [FIG. 4F]. Since the CNF is formed by a bonding of a diamond structure of carbon and a graphite structure thereof, the contact of the CNF to the near-field light generates the heat and causes a superior thermal conductivity, and therefore, the measurement with the high space resolution can be achieved.

### THIRD EMBODIMENT

In a third embodiment, the configuration of the thermocouple 20 according to the second embodiment is changed.

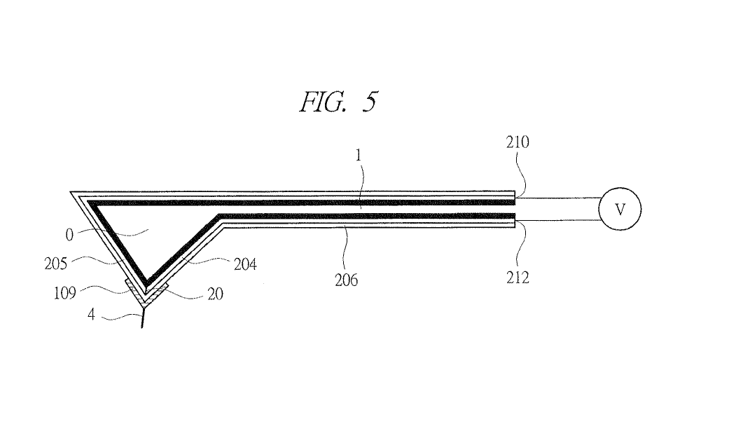

With reference to FIG. 5, a configuration of an SPM probe according to the third embodiment of the present invention is described. FIG. 5 is a configuration diagram showing the configuration of the SPM probe according to the third embodiment of the present invention.

In FIG. 5, the SPM probe includes: an SPM cantilever 1; a thermocouple 20 provided at a probe portion of the SPM cantilever 1; a wire 4 having a function of converting light provided on the thermocouple 20 into heat; metal films 204 and 205 for connecting the thermocouple 20; and electrodes 210 and 212.

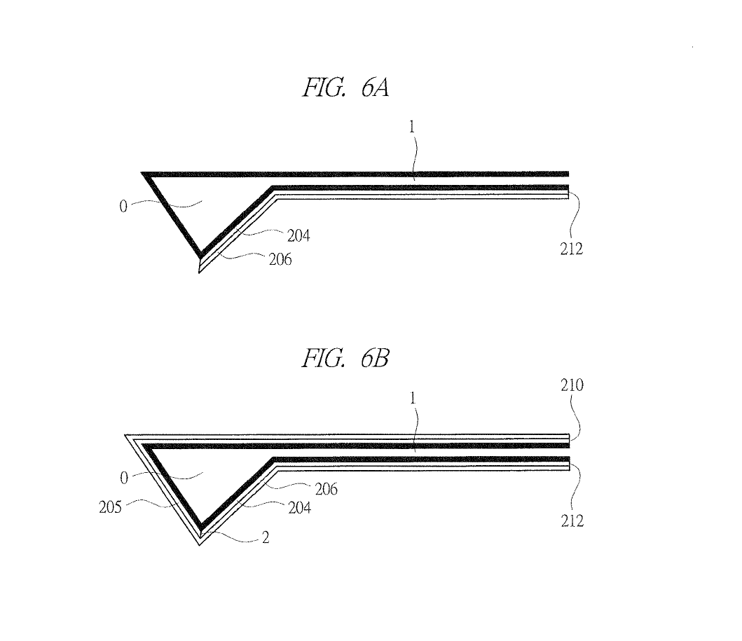

Next, with reference to FIGS. 6A and 6B, a method of manufacturing the SPM probe according to the third embodiment of the present invention is described. FIGS. 6A and 6B are diagrams each showing the method of manufacturing the SPM probe according to the third embodiment of the present invention.

In FIGS. 6A and 6B, a different point from the second embodiment is the configuration of the thermocouple 20. More specifically, different metal films 204 and 205 are coated on each of both sides of the free-end protruding portion 0 of the SPM cantilever 1, and the insulating film 206 is coated on the metal films [FIGS. 6A and 6B].

The thermocouple 20 is formed by a junction of the metal films 204 and 205 at the top point of the free-end protruding portion 0.

The subsequent deposition method of the carbon film 109 and formation method of the wire 4 are the same as those of the second embodiment, and the measurement method of the near-field light is also the same as that of the second embodiment.

### FOURTH EMBODIMENT

In a fourth embodiment, the wire 4 in the third embodiment is fixed by thermal fusion bonding or thermal conductive adhesive.

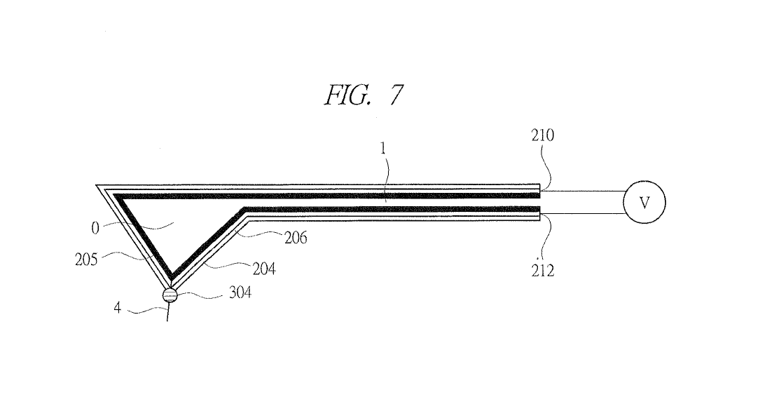

With reference to FIG. 7, a configuration of an SPM probe according to the fourth embodiment of the present invention is described. FIG. 7 is a configuration diagram showing the configuration of the SPM probe according to the fourth embodiment of the present invention.

In FIG. 7, a different point from the third embodiment is that the CNT (carbon nanotube) is used as the wire having the function of converting light into heat and the thermal conductive function. At a fix junction 304, the CNT is fixed on the thermocouple formed at the top point of the free-end protruding portion 0 by the thermal fusion bonding by irradiating electron beam or is directly fixed thereon by the thermal conductive adhesive (for example, silver plate).

Also in the case of using the CNT, similarly to the third embodiment, the contact of the CNT to the near-field light generates the heat and causes the superior thermal conductivity, and therefore, the measurement with the high space resolution can be achieved.

### FIFTH EMBODIMENT

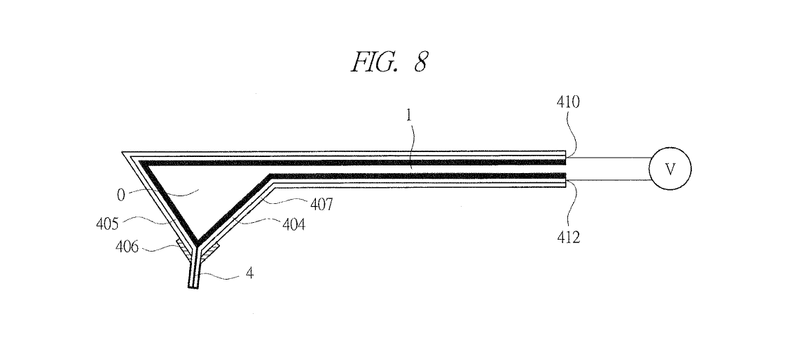

With reference to FIG. 8, a configuration of an SPM probe according to a fifth embodiment of the present invention is described. FIG. 8 is a configuration diagram showing the configuration of the SPM probe according to the fifth embodiment of the present invention.

In FIG. 8, the SPM probe includes: an SPM cantilever 1; one wire 4 having a function of converting the near-field light provided on the top point of the free-end protruding portion 0 of the SPM cantilever 1 into an electrical signal; metal films 404 and 405; an insulating film 407; and electrodes 410 and 412.

A function of each unit in the measurement is as follows.

The SPM cantilever 1 functions as same as in a general AFM device. However, the wire 4 provided at the tip portion functions as the thermocouple, and the thermocouple and the metal films 404 and 405 are energized as a part of a measurement circuit, so that a voltage of the thermocouple at the portion of the wire 4 can be measured via the electrodes 410 and 412.

The wire 4 is contacted to the measured substance (here, the near-field light) as the probe of the SPM probe, a portion contacted to the measured substance generates the heat and causes thermoelectric force due to the heat because the wire 4 has the function of converting the light into the heat and the function of the thermocouple to convert the near-field light into the electrical information, and change of its voltage value is measured via the electrodes 410 and 412, so that the near-field light can be measured.

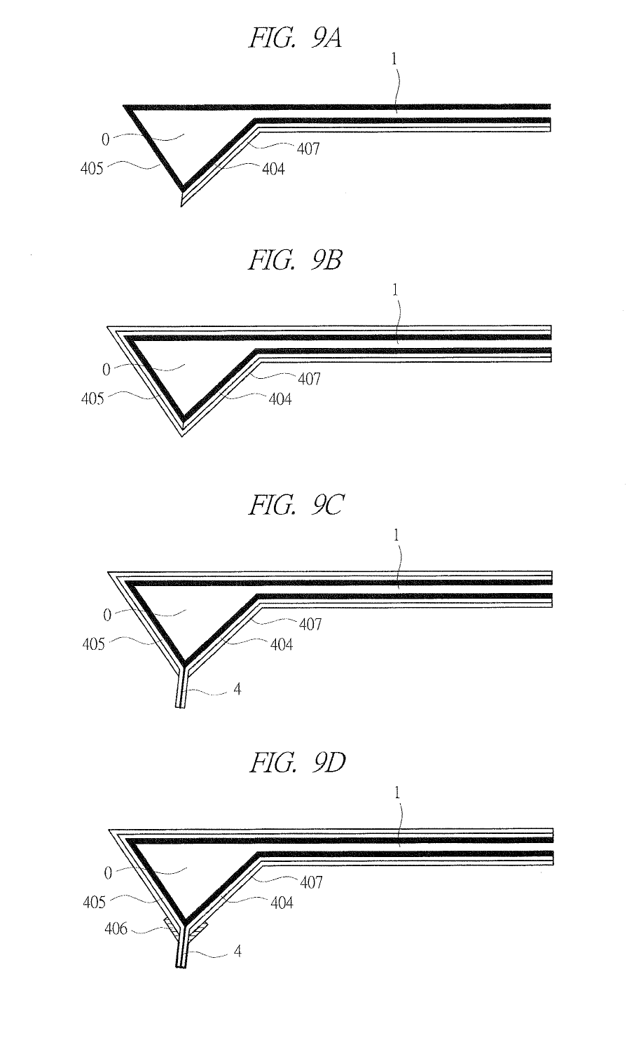

Next, with reference to FIGS. 9A to 9D, a method of manufacturing the SPM probe according to the fifth embodiment of the present invention is described. FIGS. 9A to 9D are diagrams each showing the method of manufacturing the SPM probe according to the fifth embodiment of the present invention.

First, two types of the metal films 404 and 405 are simultaneously deposited on both sides of the free-end protruding portion 0 of the SPM cantilever 1, a boundary between the two types of metals is formed at the top point of the free-end protruding portion 0, and the insulating film 407 is coated on the metal films 404 and 405 [FIGS. 9A and 9B].

At this time, by irradiating high-energy beam (in vacuum) to the top point of the free-end protruding portion 0, the wire 4 containing components of the two types of the metals can be formed at the top point of the free-end protruding portion 0 [FIG. 9C]. The wire 4 itself becomes the thermocouple, and therefore, it can detect the heat, and the contact of the wire 4 to the near-field light generates the heat, so that the measurement with high space resolution can be achieved.

Note that, if the wire 4 is made of only metal, there is a possibility that the contact to the near-field light does not generate the heat, and therefore, a non-metal film 406 (for example, carbon film) may be coated on the tip portion of the wire 4 [FIG. 9D].

### SIXTH EMBODIMENT

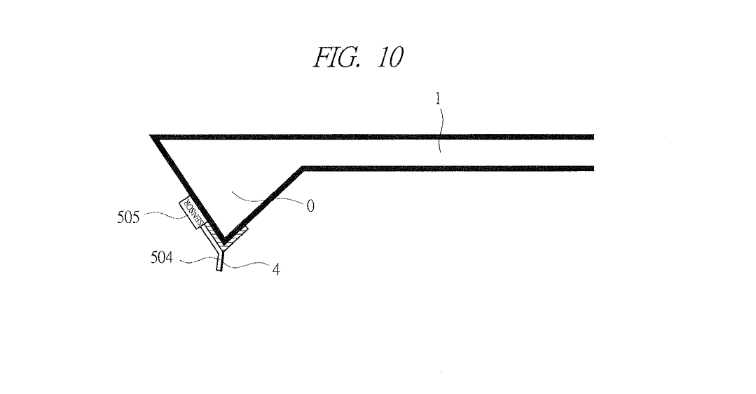

With reference to FIG. 10, a configuration of an SPM probe according to a sixth embodiment of the present invention is described. FIG. 10 is a configuration diagram showing the configuration of the SPM probe according to the sixth embodiment of the present invention.

In FIG. 10, the SPM probe includes: an SPM cantilever 1; one wire 4 having the same diameter as a size of a near-field light source provided at the top point of the free-end protruding portion 0 of the SPM cantilever 1; a metal film 504 (or metal nano particles which are uniformly distributed) coated on one side of the wire 4; and an optical sensor 505 provided at an upper end of the metal film 504.

A function of each unit in the measurement is as follows.

The SPM cantilever 1 functions as same as in a general AFM device.

The wire 4 is contacted to the measured substance (here, the near-field light) as the probe of the SPM probe. By interaction of the wire 4 with the near-field light, the near-field light is generated on the wire 4 itself. At this time, the metal film 504 provided to the wire 4 is excited by the light, and the surface plasmon is formed on the surface of the metal film 504 (or metal nano particles which are uniformly distributed) coated on one side of the wire 4 and is propagated to the upper end of the metal film 504. At last, by the optical sensor 505 provided at the upper end of the metal film 504, optical information of the surface plasmon resonance on the metal film 504 due to the measured near-field light is detected.

By measuring a result of the detection by the optical sensor 505, the near-field light can be measured.

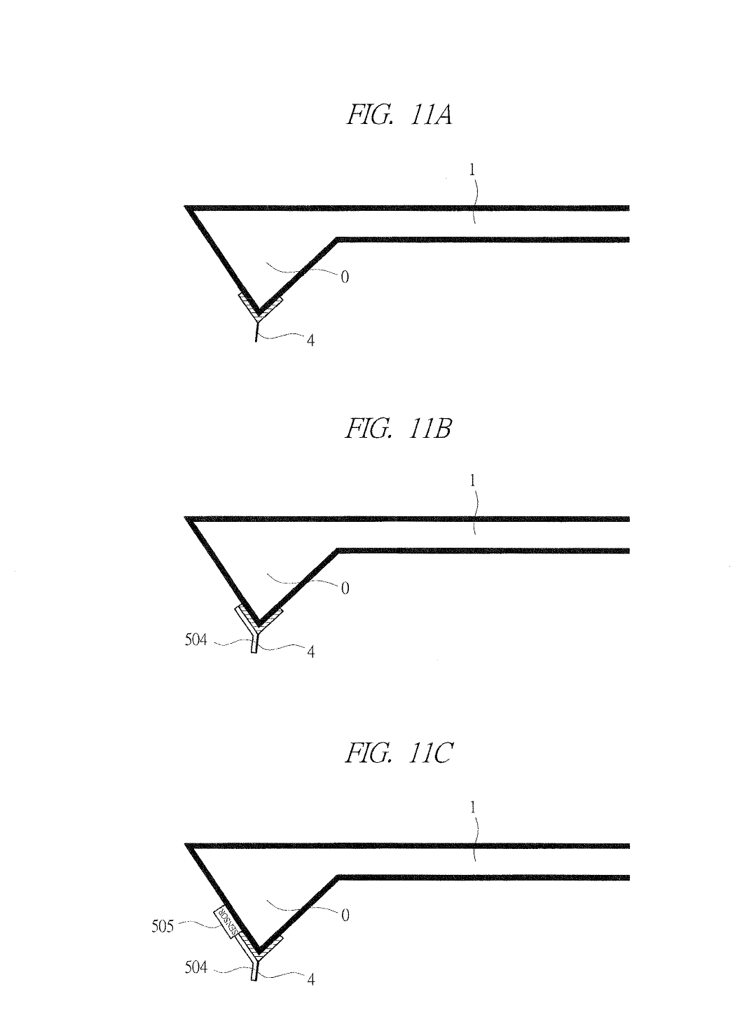

Next, with reference to FIGS. 11A to 11C, a method of manufacturing the SPM probe according to the sixth embodiment of the present invention is described. FIGS. 11A to 11C are diagrams each showing the method of manufacturing the SPM probe according to the sixth embodiment of the present invention.

First, at the top point of the free-end protruding portion 0 of the SPM cantilever 1, the wire 4 is provided similarly to the first embodiment [FIG. 11A]. By a sputtering method, an electron-beam evaporation method, a CVD method, or others (since it is considered that the cantilever with the wire does not depend on a state of a raw material much), the metal film 504 [or uniformly-distributed precious metal particles (in which the precious metal particles are uniformly distributed in a nanometer-order size, and besides, precious metal particles adjacent to each other are faced to each other with an appropriate distance of 10 nm or smaller)] is formed on one side of the wire 4 [FIG. 11B].

At last, at the upper end of the metal film 504, the optical sensor 505 having a micro size is provided [FIG. 11C].

### SEVENTH EMBODIMENT

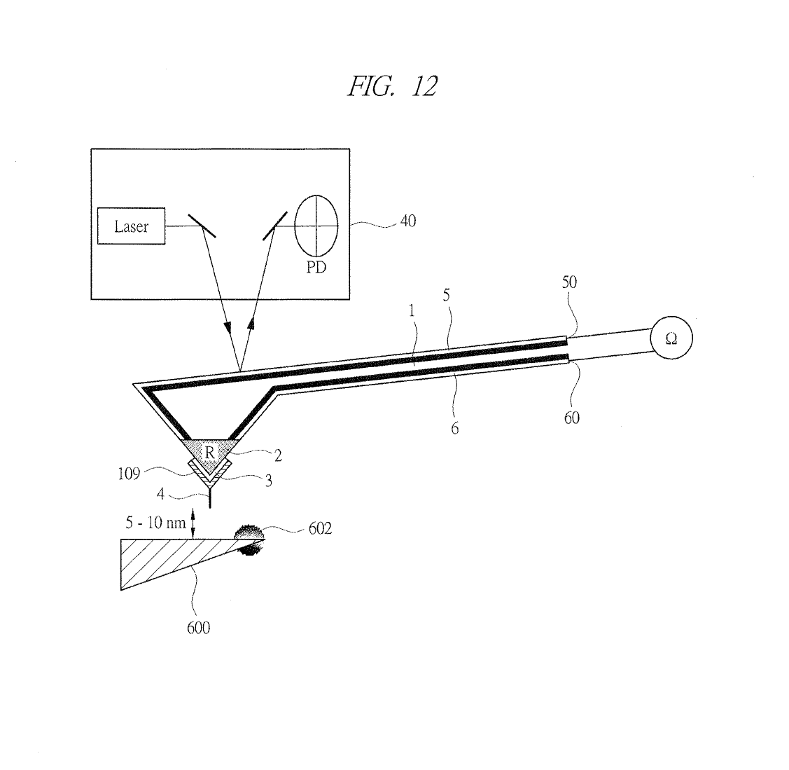

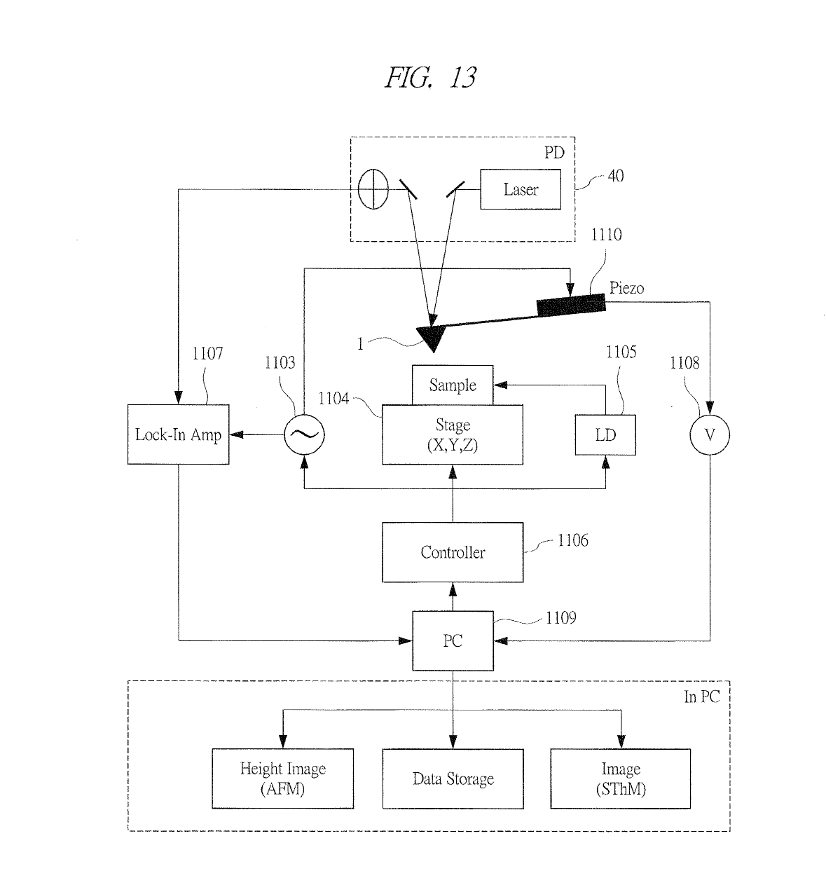

With reference to FIGS. 12 and 13, a configuration of an inspection device for a light emission unit with using an SPM probe according to a seventh embodiment of the present invention is described. FIG. 12 is a diagram showing a basic configuration of an inspection device for a near-field light emission unit with using the SPM probe according to the seventh embodiment of the present invention, and FIG. 13 is a diagram showing a device configuration of the inspection device for the near-field light emission unit with using the SPM probe according to the seventh embodiment of the present invention.

In FIG. 12, with using an SPM probe including an optical lever 40 and an SPM cantilever 1, a near-field light emission unit 602 of a thermally-assisted magnetic head 600 is measured, and an AFM signal is outputted, so that the near-field light is measured. In an example shown in FIG. 12, the SPM probe in the first embodiment is shown. However, the SPM probe in each of the second to sixth embodiments may be used.

In FIG. 13, the device configuration of the inspection device for the near-field light emission unit is almost the same as that of the AFM, and mainly includes: the SPM probe including the optical lever 40 and the SPM cantilever 1; an alternating-current signal sending unit 1103 (which sends an oscillation signal to an piezo body (piezoelectric element) 1110 of oscillating the SPM cantilever 1); a stage 1104; a laser diode 1105 by which a sample is light emitted; a controller 1106 for driving the above-described three units; a lock-in amplifier 1107 for comparing the oscillation signal of the SPM cantilever 1 with the signal of the optical lever 40 and outputting the AFM signal; a detector 1108 for detecting heat or a potential signal of the optical sensor (or a potential signal corresponding to a resistance value); and a calculator 1109 of performing functions such as signal processing/storage and image creation.

In the calculator 1109, information of an image of the AFM, an image of the heat (SThM), or others is stored, and the near-field light is measured with using the information in the calculator 1109.

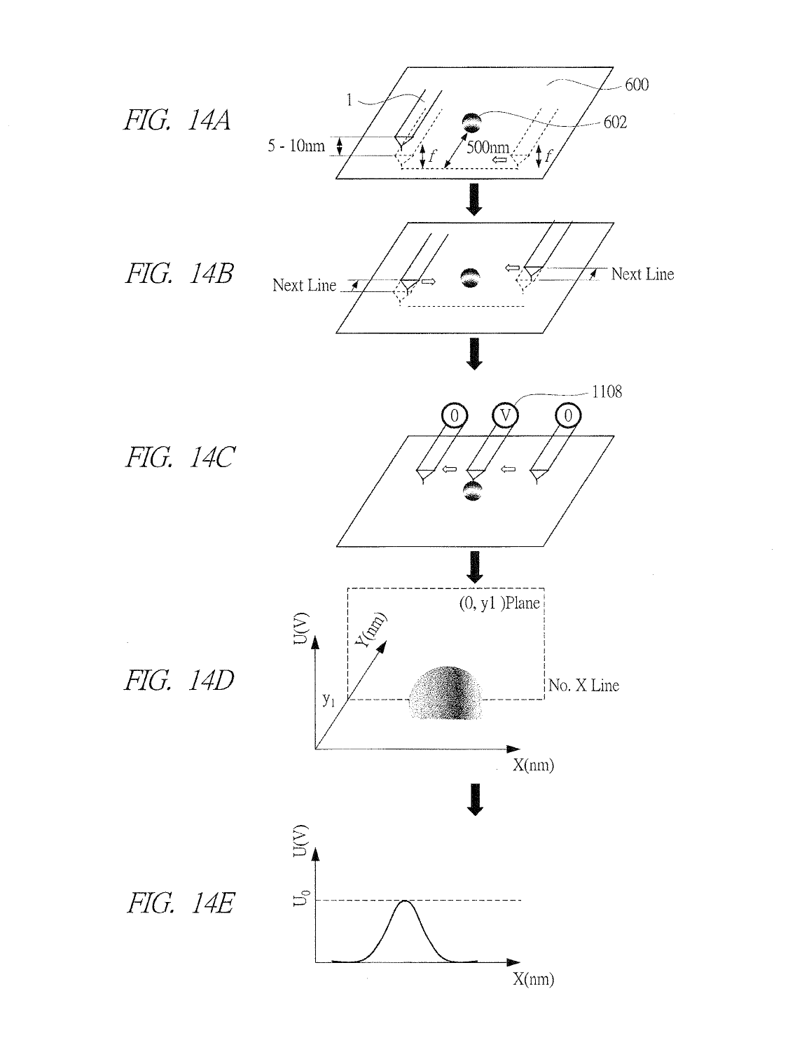

Next, with reference to FIGS. 14A to 14E, a procedure in measurement by the inspection device for the near-field light emission unit with using the SPM probe according to the seventh embodiment of the present invention is described. FIGS. 14A to 14E are diagrams each showing the procedure in measurement by the inspection device for the near-field light emission unit with using the SPM probe according to the seventh embodiment of the present invention.

First, the SPM cantilever 1 scans in an AFM mode as oscillating for a first line which is about 500 nm away from the near-field light emission unit 602 of the thermally-assisted magnetic head, so that information of a shape (height) in a vicinity of the near-field light emission unit is detected.

Next, based on a result of the first line, the SPM cantilever 1 is lifted to a height which is 5 to 10 nm above from the light emission unit [FIG. 14A].

And then, the oscillation in the piezo element in the AFM made is stopped, and it scans for the rest of inspection locations [FIG. 14B]. By contacting the probe (wire 4) to the near-field light emission unit 602 based on the above-described principle, the heat or the optical information generated at the tip portion of the wire 4 and detected by a thermal sensor (or an optical sensor) provided to the SPM. cantilever 1 is detected by the detector 1108 [FIG. 14C].

A two-dimensional thermal or optical space distribution after data processing by the calculator 1109 is shown as FIG. 14D. Here, an expected diagram of a measurement result for an X-th scan line (that is a (0, y1) plane shown by a dotted line) is shown as FIG. 14E.

In this manner, this can be corresponded to the space distribution of the near-field light generated from the near-field light emission unit 602 of the thermally-assisted magnetic head 600.

In the foregoing, the invention made by the inventors has been concretely described based on the embodiments. However, it is needless to say that the present invention is not limited to the foregoing embodiments and various modifications and alterations can be made within the scope of the present invention.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The present invention relates to an SPM probe for measuring energy of the near-field light (micro-scale energy source) and can be widely applied to a device or a system for which the high resolution is required.

What is claimed is:

1. An SPM probe for detecting a micro-scale energy source comprising:
an SPM cantilever;
a thermal resistance formed at a probe portion of the SPM cantilever;
an insulating film formed on the thermal resistance; and
one wire for converting the micro-scale energy source into heat, formed on the insulating film.

2. An SPM probe for detecting a micro-scale energy source comprising:
an SPM cantilever;
a thermocouple formed at a probe portion of the SPM cantilever;
an insulating film formed on the thermocouple; and
one wire for converting the micro-scale energy source into propagating light and amplifying the light by generating surface plasmon, formed on the insulating film.

3. An SPM probe for detecting a micro-scale energy source comprising:
an SPM cantilever;
an optical sensor formed at a tip portion of the SPM cantilever;
one wire for converting the micro-scale energy source into heat, formed at a probe portion of the SPM cantilever; and
a metal film or a metal particle layer for propagating light generated between the wire and the optical sensor.

4. The SPM probe according to claim 1, wherein
the wire is made of a material which converts the micro-scale energy source into the heat when the wire is contacted to the micro-scale energy source.

5. The SPM probe according to claim 2, wherein
the wire is made of a material which converts the micro-scale energy source into the propagating light when the wire is contacted to the micro-scale energy source.

6. The SPM probe according to claim 3, wherein
the wire is made of a material which converts the micro-scale energy source into the heat when the wire is contacted to the micro-scale energy source.

7. The SPM probe according to claim 1, wherein
the insulating film is made of a material with good thermal conductivity.

8. The SPM probe according to claim 2, wherein
the insulating film is made of a material with good thermal conductivity.

9. The SPM probe according to claim 3, wherein
the insulating film is made of a material with good thermal conductivity.

10. The SPM probe according to claim 3, wherein
the wire is coated by a material which generates surface plasmon at a tip portion of the wire when the wire is contacted to the micro-scale energy source and converts the micro-scale energy source into propagating light.

11. The SPM probe according to claim 10, wherein
the metal film or the metal particle layer causes resonance with the surface plasmon generated at the tip portion of the wire, and propagates optical information of the resonance with the surface plasmon to the optical sensor.

12. An inspection device for a light emission unit comprising:
the SPM probe according to claim 1;
an optical lever for measuring a displacement of the SPM cantilever of the SPM probe;
an alternating-current signal sending unit for sending an oscillation signal to the SPM cantilever;
a lock-in amplifier for comparing the oscillation signal with an optical-lever signal from the optical lever and outputting an AFM signal; and
a calculator for calculating a space distribution of the micro-scale energy source based on an output signal from the lock-in amplifier and an output signal from the SPM probe.

13. An inspection device for a light emission unit comprising:
the SPM probe according to claim 2;
an optical lever for measuring a displacement of the SPM cantilever of the SPM probe;
an alternating-current signal sending unit for sending an oscillation signal to the SPM cantilever;
a lock-in amplifier for comparing the oscillation signal with an optical-lever signal from the optical lever and outputting an AFM signal; and
a calculator for calculating a space distribution of the micro-scale energy source based on an output signal from the lock-in amplifier and an output signal from the SPM probe.

14. An inspection device for a light emission unit comprising:
the SPM probe according to claim 3;
an optical lever for measuring a displacement of the SPM cantilever of the SPM probe;
an alternating-current signal sending unit for sending an oscillation signal to the SPM cantilever;
a lock-in amplifier for comparing the oscillation signal with an optical-lever signal from the optical lever and outputting an AFM signal; and
a calculator for calculating a space distribution of the micro-scale energy source based on an output signal from the lock-in amplifier and an output signal from the SPM probe.
